(19) United States
(12) Patent Application Publication
(10) Pub. No.: US 2026/0236893 A1
(43) Pub. Date: Aug. 13, 2026

(54) WEATHER-DRIVEN EVENT SCHEDULING SYSTEM

(71) Applicant: CELLIGENCE INTERNATIONAL LLC, Guaynabo, PR (US)

(72) Inventors: Pavan AGARWAL, Dorado, PR (US); Gabriel Albors Sanchez, San Juan, PR (US); Jonathan Ortiz Rivera, San Juan, PR (US)

(73) Assignee: CELLIGENCE INTERNATIONAL LLC, Guaynabo, PR (US)

(21) Appl. No.: 19/540,177

(22) Filed: Feb. 13, 2026

Related U.S. Application Data
(60) Provisional application No. 63/758,240, filed on Feb. 13, 2025.

(51) Int. Cl. G06Q 10/1093

(52) U.S. Cl. CPC G06Q 10/1093

(57) ABSTRACT

Systems and methods are provided for optimizing event scheduling based on weather forecasts and historical event attendance data. The system employs machine learning algorithms to analyze weather conditions, historical attendance trends, and user preferences to automatically recommend optimal event dates. By incorporating real-time weather updates and adaptive recommendations, the system ensures dynamic event scheduling that maximizes attendance and aligns with user preferences. This innovation enhances the event planning process by providing data-driven, weather-based scheduling suggestion.

### RELATED APPLICATIONS

This application claims the benefit of U.S. Provisional Application No. 63/758,240 filed on Feb. 13, 2025, the entirety of which is incorporated herein by reference.

### BACKGROUND

Event attendance is often significantly impacted by weather conditions. Traditional event planning methods do not account for weather forecasts, leading to suboptimal event scheduling. For example, scheduling an open house during inclement weather can reduce attendance, while favorable weather conditions could result in increased foot traffic. Existing event planning solutions are not equipped to dynamically adapt event scheduling based on weather conditions.

Therefore, there exists a need for a system that integrates weather forecast analysis with historical event attendance data, leveraging predictive modeling to optimize event scheduling. This system improves event outcomes by providing data-driven, weather-based recommendations to users, such as real estate agents, property sellers, or event organizers.

### SUMMARY

In accordance with one or more embodiments, the disclosed system integrates various data sources and machine learning techniques to predict and recommend the optimal event dates based on weather, historical attendance, and user preferences. The machine learning models continuously improve over time, allowing the system to provide accurate and dynamic event scheduling recommendations, ensuring users receive the best possible event dates based on changing weather conditions and other relevant factors.

In some embodiments, the weather-driven event optimization system further generates host-assistance recommendations that improve an event experience beyond selection of an event date. For example, based on an event type, forecasted conditions, and historical event performance, the weather-driven event optimization system recommends purchases, services, or upgrades for the planned event, including heaters, umbrellas, lighting, catering add-ons, or entertainment options.

In some embodiments, the weather-driven event optimization system identifies invitee accounts associated with the planned event and uses stored preference signals and behavioral insights to generate group-level personalization recommendations. For example, the weather-driven event optimization system recommends food selections, music selections, lighting configurations, and seating layouts based on aggregated preferences of a set of invitees, while maintaining privacy constraints by using anonymized or aggregated features.

In some embodiments, the weather-driven event optimization system generates alternative event experiences responsive to forecast changes. For example, upon detecting adverse weather conditions relative to a baseline forecast, the weather-driven event optimization system generates a plan B experience that converts an outdoor gathering to an indoor layout, applies a weather-compatible theme, or proposes a hybrid virtual extension. The weather-driven event optimization system further learns from post-event outcomes and feedback to improve subsequent recommendations for hosts and invitees.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIGS. 1A-1B illustrate a weather-driven event optimization system, according to an implementation of the disclosure.

FIG. 2 illustrates an example diagram of a weather-driven event optimization server for an exemplary illustrative weather-driven event optimization system in FIGS. 1A-1B, according to an implementation of the disclosure.

FIG. 3 is a flowchart illustrating a process for selecting an optimal date for a planned event based on weather forecasts, historical event attendance data, and user preferences, according to an implementation of the disclosure.

FIG. 4 illustrates an example computing system that may be used in implementing various features of embodiments of the disclosed technology.

Described herein are systems and methods for optimizing event scheduling based on weather forecasts and historical event attendance data by employing machine learning algorithms. These algorithms analyze weather conditions, user preferences, and historical trends to predict optimal event dates, allowing for real-time updates and adaptive recommendations based on changing weather conditions. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present disclosure relates to event scheduling and optimization systems, and more specifically to a weather-driven event optimization system that employs machine learning algorithms to analyze weather forecasts and historical event attendance data. This system provides recommendations for scheduling events, such as open houses, with the goal of maximizing attendance and overall event success. The invention addresses technical challenges in event planning by utilizing real-time weather data and predictive analytics.

As alluded to earlier, when selecting a date for an open house realtors face many event scheduling challenges, such as, for example, understanding how external or non-property related factors, including weather may impact their choice. In other words,

when evaluating weather forecast conditions (e.g., mild conditions, rain storm), the realtors may also may consider geographic location (e.g., beach town, suburbs, city), property attributes (e.g., price range, number of bedrooms, improvements, new construction), neighborhood (e.g., family, empty nester), sale type (e.g., foreclosure, traditional sale, number of days on the market), target audience attributes (e.g., large families, high net worth individual, investors, flippers, and so on), external conditions (e.g., spring break, vacation season, holidays, other events in the area), weather forecast conditions (e.g., mild conditions, rain storm), market conditions (e.g., buyer's market, sellers' market), and other such similar other factors.

An experienced realtor may know that families tend to purchase homes before the beginning of school year, while empty nesters are active all year round. Similarly, an open house in an east coast neighborhood may increase attendance when scheduled on a sunny day, while a property on a west coast beach neighborhood may benefit from being shown during less-than-optimal weather. However, a novice realtor or a realtor not familiar with a territory may not be aware of these peculiarities. Moreover, additional factors as described above may further impact the event scheduling date (e.g., what other events are already scheduled in the same area during the same time, how many people who might be interested in the open house are actually available to attend, and the like) need to be considered to have a successful open house, but are not in the realtor's current knowledgebase. Furthermore, realtors may be satisfied with their current event management system but for the date selection aspect.

### Integrates Well by Having a Small AI Component

The following embodiments provide technical solutions or technical improvements that overcome technical problems, drawbacks or deficiencies in the technical fields involving task event planning, in a robust, accurate and efficient manner to improve the performance and usability of event planning management programs and applications, among others.

### Technical Improvement

Many event scheduling systems currently available are based on static date selection or simple filtering, which often does not account for the dynamic nature of weather conditions. While some systems may provide basic event scheduling features, these do not integrate real-time weather forecasts or predict the impact of weather on event attendance. As a result, event organizers often struggle to schedule events that maximize attendee participation, especially when unexpected weather changes occur. Existing systems fail to provide intelligent, data-driven recommendations that adjust event dates based on changing weather patterns, leaving event success largely to chance.

The weather-driven event optimization system improves upon current scheduling methods by utilizing machine learning to analyze both weather data and historical event attendance patterns. By correlating weather forecasts with factors that affect event turnout, such as temperature, precipitation, and wind conditions, the system generates more accurate and effective recommendations for event dates. This integration of multiple data sources enables more intelligent decision-making, optimizing scheduling based on both weather forecasts and past event outcomes. As the system gathers more data over time, it learns from patterns of attendance relative to weather conditions, allowing for more refined, proactive recommendations and better predictions of future event success. The system not only enhances event planning but also improves the efficiency of operations by conserving computing resources, as it continuously adapts to user needs and weather trends, reducing the need for manual adjustments and maximizing the impact of each event.

### Main System

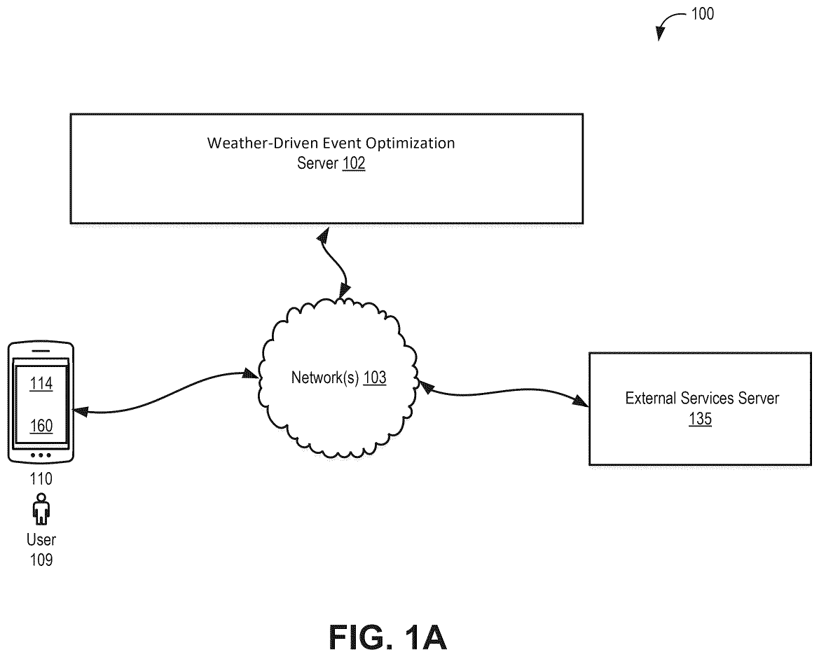

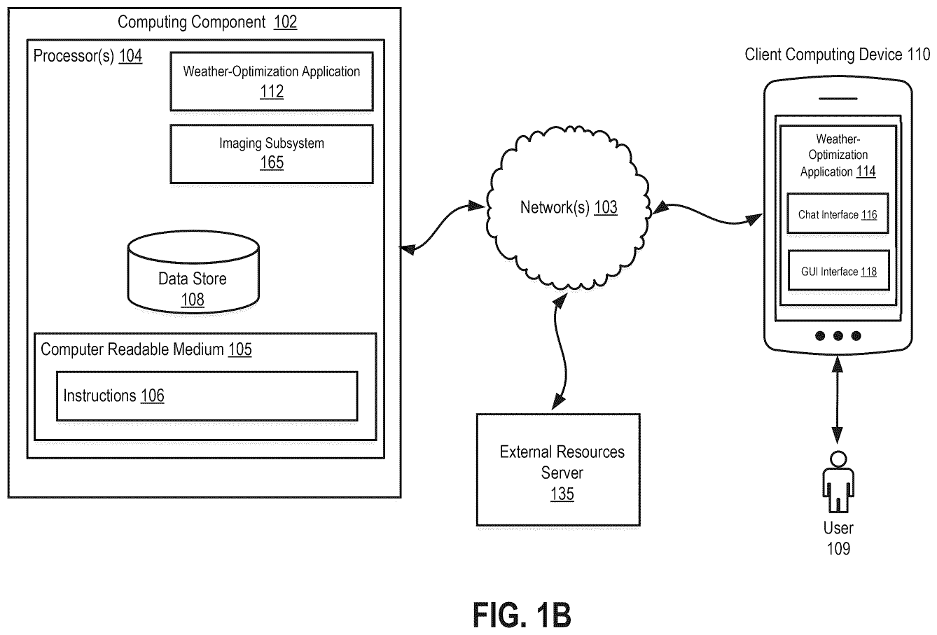

FIG. 1A illustrates an exemplary weather-driven event optimization system 100, in accordance with the embodiments disclosed herein. The weather-driven event optimization system 100 comprises several key components designed to enhance the scheduling and optimization of events based on weather forecasts. The system 100 includes a weather-driven event optimization server 102, which communicates with a network 103 and one or more external resources server 135. A user, e.g., user 109, interacts with the system via client computing device 110, which runs the weather optimization application 114, providing the user with access to event optimization functionalities. The server 102 serves as the central processing unit of the system, interacting with external resources and the client devices such as device 110 via the network 103. External resources server 135 may be located in a different physical or geographical location from the computing component 102.

In some embodiments, the weather-driven event optimization system 100 can access user schedule and communication data to facilitate the decision-making process for event scheduling. This includes predicting the best dates and times for an event based on weather conditions, historical event data, and real-time weather updates. The system processes this data to suggest the most optimal event schedules, providing users with recommendations on when to hold events like open houses based on weather forecasts.

As illustrated in FIG. 1B, the weather-driven event optimization server 102 includes a computing component with processors 104 configured to execute weather-driven event optimization application 112. This application accesses a data store 108, which stores essential event and weather-related data, including historical event attendance records, real-time weather information, and predictive models. The processor executes instructions 106 stored on a computer-readable medium 105, ensuring that the system can provide accurate and timely weather-driven event scheduling recommendations.

The system relies on the weather-driven optimization application 112 to analyze weather data and correlate it with user preferences and historical attendance trends. This data is used to predict optimal dates for events based on weather conditions such as temperature, precipitation, and wind speed. The results are stored in the data store 108 and are accessed dynamically to provide real-time updates to users.

In some embodiments, the weather-optimization application 112 generates host-assistance recommendations for a planned event. The host-assistance recommendations can include item recommendations (for example, umbrellas, heaters, fans, canopies), service recommendations (for example, catering add-ons, valet services, rentals), and experience recommendations (for example, lighting themes, music playlists, seating arrangements), where each recommendation is selected based on forecast conditions, event attributes, and historical performance of similar events.

In some embodiments, the weather-driven event optimization system 100 identifies one or more invitees associated with the planned event and determines group-level preference parameters. The group-level preference parameters can be determined from stored user preference data, inferred behavioural insights, or prior event feedback associated with the invitees. In some embodiments, the weather-driven event optimization system 100 computes aggregated preference signals used to personalize event atmosphere recommendations without exposing individual invitee preferences to other invitees.

In some embodiments, the weather-driven event optimization system 100 generates an alternate experience plan responsive to forecast changes. The alternate experience plan can include a venue conversion plan, a weather-compatible theme plan, and a hybrid extension plan. The alternate experience plan may be generated and updated as the forecast changes, and may be surfaced to the user via the chat interface 116 or GUI interface 118.

### Computing Component 102

As illustrated in FIG. 1, computing component or server 102 may be, for example, a server computer, a controller, or any other similar computing component capable of processing data. In the example implementation of FIG. 1, computing component 102 includes a hardware processor 104 configured to execute one or more instructions residing in a machine-readable storage medium 105 comprising one or more computer program components.

### Hardware Processor 104

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

### Storage Medium 105

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

### Client Computing Device 110

The client computing device 110 acts as the interface through which user 109 interacts with the system. The device is equipped with the weather-driven optimization application 114, which includes both a chat-based interface 116 and a GUI interface 118. Through these interfaces, users can input event details, view recommended event dates, and adjust their preferences for event scheduling.

In some embodiments, client computing device 110 may be equipped with GPS location tracking and may transmit geolocation information via a wireless link and network 103. In some embodiments, computing component 102 and/or distributed weather-driven optimization application 112 may use the geolocation information to determine a geographic location associated with the user. In some embodiments, computing component 102 may use signal transmitted by client computing device 110 to determine the geolocation of the user based on one or more of signal strength, GPS, cell tower triangulation, Wi-Fi location, or other input. In some embodiments, the geolocation associated with the user may be used by one or more computer program components associated with client computing device 110. This allows the server 102 to tailor recommendations based on the user's geographic location and nearby weather forecasts, ensuring more precise and relevant event scheduling. By utilizing GPS data, the system can optimize event recommendations based on location-specific weather patterns and user preferences, enhancing the relevance of the suggested dates and times.

In some embodiments, computing component 102 may include one or more distributed applications implemented on client computing device 110 (e.g., weather-driven optimization application 114) as client applications.

In some embodiments, the weather-driven event optimization system 100 includes an imaging subsystem 165 configured to provide spatial and environmental intelligence for a planned event location. The imaging subsystem 165 may be executed by the weather-driven event optimization server 102 and may receive image data captured by a vision camera 160 associated with, or in communication with, client computing device 110.

In some embodiments, the vision camera 160 captures image data of an event location and the client computing device 110 transmits the image data to the weather-driven event optimization server 102 via network(s) 103. In some embodiments, the transmitted image data is associated with location data for the planned event, including GPS-derived coordinates received from client computing device 110, so that the location data is preserved and repurposed by the weather-driven event optimization system 100 to select forecast data for the correct geographic area and to bind the image data to the planned event.

In some embodiments, the imaging subsystem 165 generates a visual preview of how the event location is expected to look, feel, or function under different weather conditions. In some embodiments, the imaging subsystem 165 generates multiple weather perspectives for the event location, including sun, rain, snow, or overcast perspectives, by applying environmental transforms to captured image data, by rendering simulated overlays based on forecast parameters from external resources server 135, or by combining both.

In some embodiments, the visual preview is presented at client computing device 110 via a chat interface 116 or GUI interface 118 of weather-optimization application 114 to enable a user to visually compare scenarios and select a date, time, layout, or alternative experience plan for the planned event based on the visualized weather impacts.

As illustrated in FIG. 1A, client computing device 110 may include weather-optimization application 114 and vision camera 160, and as illustrated in FIG. 1B, weather-driven event optimization server 102 may include weather-optimization application 112 and imaging subsystem 165 configured to process image data received from client computing device 110.

### Chat-Bot

In some embodiments, automated software assistants or bots may be provided by a distributed task management application 112. For example, the automated assistant or bot may interact with users through text, e.g., via chat interface of task management application 112. In some embodiments, an automated assistant may be implemented by an automated assistant provider such that it is not the same as the provider of distributed chat application 112.

In some embodiments, an automated software assistant or chat-bot may be incorporated into the weather-driven optimization application 114 running on client computing device 110. The chat-bot interacts with users e.g., user 109, through a conversational interface, providing event recommendations and updates based on weather forecasts, location, and user preferences. This interaction is facilitated by the distributed weather-driven optimization application 112, which resides on the weather-driven event optimization server 102. The application on the server processes the necessary data and sends relevant information to the client app, allowing the chat-bot to present users with weather-driven event suggestions or reschedule events as needed. In some embodiments, the automated assistant may be provided by a third-party service and integrated with the system, enhancing the user experience by delivering personalized recommendations and assistance through the chat interface.

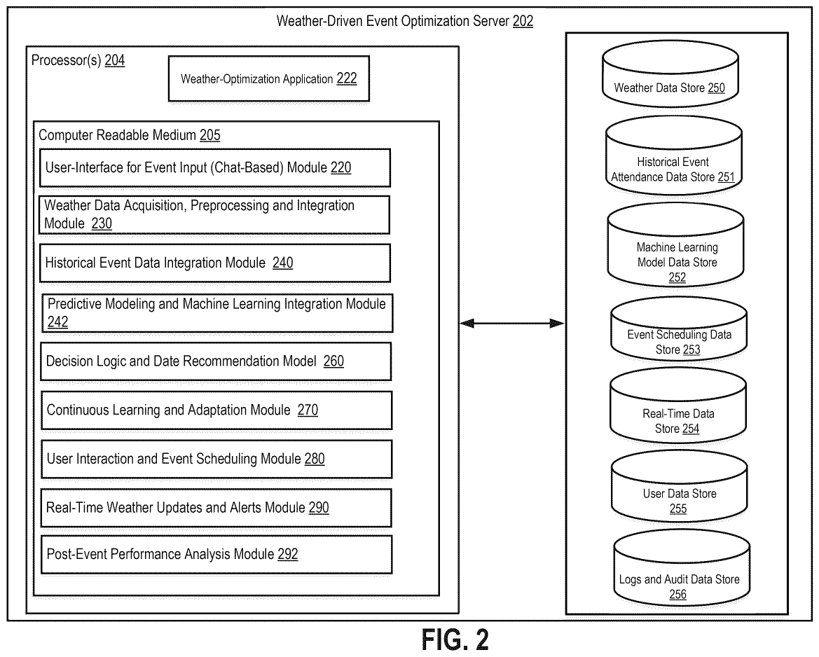

FIG. 2 illustrates the architecture of the weather-driven event optimization server 202 of the weather-driven event optimization system. For example, the system may be weather-driven event optimization system 100 and the server may be weather-driven event optimization server 102 illustrated in FIGS. 1A and 1B. The central weather-driven event optimization server 102 is configured to integrate various components and modules designed to provide optimized event scheduling recommendations based on weather forecasts, historical attendance data, and user preferences. The server 102 communicates with a client computing device (e.g., device 110 illustrated in FIGS. 1A and 1B) via a network (e.g., network 103 illustrated in FIGS. 1A and 1B), allowing users to input event details, view recommendations, and adjust preferences. The core processing of data and event recommendations is driven by the weather-driven optimization application 222 housed on the server, which interacts with several key data sources and machine learning models to optimize event scheduling.

The weather-driven event optimization server 202 is designed to optimize event scheduling by using real-time weather data, historical attendance data, and user preferences. This system includes several key modules that work together to provide recommendations for the best event dates based on weather forecasts and user inputs.

### Modules Overview

As illustrated in FIG. 2, weather-driven event optimization server 202 includes a hardware processor 204 configured to execute one or more instructions residing in a machine-readable storage medium 205 comprising one or more computer program components. Processor 204 may fetch, decode, and execute instructions including, for example, user interface for event input (chat-based) module 220, weather data acquisition, processing, and integration module 230, historical event data integration module 240, predictive modeling module 242, decision logic and date recommendation module 260, continuous learning and adaptation module 270, user interaction and event scheduling module 280, real-time weather updates and alerts module 290, and post-event performance data analysis module 292.

The user interface for event input (chat-based) module 220 allows users to easily interact with the system via a conversational interface. Users can input event details such as event type (e.g., open house, a conference, a wedding, etc.), date range, location (e.g., the venue or geographical area where the event will take place), date and time (e.g., the planned date and time for the even event duration), duration (e.g., how long the event is expected to last), event capacity (e.g., number of expected attendees or the size of the venue), event format (e.g., whether it is an indoor or outdoor event, virtual or in-person, etc.), and user preferences (e.g., how the user wants the event to be scheduled, including referred day of the week, time of day). This module 220 enables seamless communication with the system and ensures users can easily receive and adjust event recommendations based on their inputs.

The weather data acquisition, processing, and integration module 230 is responsible for gathering and processing weather data from external sources. It retrieves real-time weather forecasts and historical weather data, then preprocesses this data to ensure it is consistent and usable for event optimization. This module 230 integrates the processed weather data into the system to support decision-making and ensures that weather conditions are always accurately reflected in the event scheduling process.

The historical event data integration module 240 collects and processes data from past events, including attendance numbers, weather conditions, and event types. By analyzing this historical data, the system can predict how similar events will perform under comparable weather conditions, which helps optimize future event scheduling by identifying patterns and trends in historical attendance.

The predictive modeling module 242 applies machine learning techniques, such as decision trees and neural networks, to analyze weather data, user preferences, and historical event data. The module 242 generates predictions about the optimal event dates by factoring in how weather conditions and user preferences affect attendance, ensuring that events are scheduled for the most favorable times.

The decision logic and date recommendation module 260 takes the predictions from the predictive modeling module 242 and applies logic to recommend the best dates for an event. This module works with the event scheduling data store 253 to ensure that the recommendations align with user needs and event scheduling details, producing a ranked list of optimal dates to maximize event attendance.

The continuous learning and adaptation module 270 enables the system to improve over time. As new event and weather data are collected, this module helps refine the machine learning models, making the system more accurate in its predictions and recommendations as more data becomes available.

The user interaction and event scheduling module 280 allows users to review and modify event recommendations. Through this module 280, users can adjust their preferences and interact with the system to finalize event scheduling, ensuring that the system's recommendations align with their needs.

The real-time weather updates and alerts module 290 ensures that the system is always up to date with the latest weather conditions. If there are any sudden changes in the forecast, such as a storm or temperature fluctuation, this module 290 updates the event recommendations in real-time to account for the new weather data.

Finally, the post-event performance data analysis module 292 analyzes the actual attendance of events after they take place, comparing it with the predicted attendance based on weather conditions and scheduling. This feedback helps refine the system's future recommendations, allowing the system to continuously improve and provide more accurate event date suggestions in the future.

### Multiple Data Sources

The weather-driven event optimization system 202 relies on multiple data sources to gather comprehensive event and weather-related information, which is crucial for optimizing event schedules. The system receives real-time weather data, historical event attendance records, and user preferences, and uses this data to suggest the best possible event dates based on weather conditions and user inputs. These data sources are stored in several interconnected data stores, each serving a specific purpose to ensure smooth data processing, accurate predictions, and continuous learning.

The weather data store 250 contains both historical and real-time weather data, such as temperature, precipitation, wind speed, and sunshine forecasts. This data helps the system predict how weather conditions will impact event attendance and recommend optimal event dates based on favorable weather. By analyzing historical weather trends alongside current forecasts, the system identifies the best days for events, ensuring maximum turnout by aligning weather conditions with user preferences.

The historical event attendance data store 251 holds data about past events, including event types (e.g., open house, conference, etc.), location, event date, attendance numbers, and the weather conditions at the time. This historical data helps the system make predictions about how future events will perform under similar weather conditions. By learning from past events, the system determines which weather conditions led to higher or lower attendance, improving its event date suggestions.

The machine learning model data store 252 stores critical information related to the system's predictive models. This includes model parameters such as the weights, biases, and other learned factors that the machine learning models use to make predictions. The store also holds training data—historical weather and event attendance data that the models use to learn how weather affects event attendance. Additionally, prediction results are stored here, allowing the system to continually refine its predictions based on new inputs and outcomes.

The event scheduling data store 253 stores details about upcoming or scheduled events, including event dates, times, locations, user preferences, and recommended event dates based on weather analysis. This data helps track the status of events, user preferences for scheduling, and any modifications or updates made to the original schedule.

The real-time data store 254 manages the most current weather information and event-related updates. This includes near-future forecasts, weather alerts, and any immediate event schedule changes, which the system uses to adjust recommendations dynamically. For example, if a storm is forecasted near the event date, the system will suggest alternative dates or venues to ensure the event is not negatively impacted by the weather.

The user data store 255 houses personalized information about each user, such as event preferences (e.g., preferred event types and scheduling times) and geolocation data collected from the client computing device 110. This allows the system to suggest events based on local weather conditions and the user's location, enhancing the relevance of recommendations.

The logs and audit data store 256 tracks system performance, user actions, and decisions made during event scheduling. This includes logs for system operations, errors, and actions taken by users (e.g., accepting or modifying event dates). This data is crucial for auditing, troubleshooting, and improving system performance over time.

Together, these data stores ensure the system can process real-time inputs, predict optimal event dates, and store historical data for continuous improvement. By integrating weather forecasts, user preferences, historical attendance, and machine learning, the weather-driven event optimization system 202 provides accurate, data-driven recommendations for scheduling events at the most favorable times based on weather conditions and user preferences.

As used herein, a “database” refers to any suitable type of database or storage system for storing data. A database may include centralized storage devices, a distributed storage system, a blockchain network, and others, including a database managed by a database management system (DBMS). In some embodiments, an exemplary DBMS-managed database may be specifically programmed as an engine that controls organization, storage, management, or retrieval of data in the respective database. In some embodiments, the exemplary DBMS-managed database may be specifically programmed to provide the ability to query, backup and replicate, enforce rules, provide security, compute, perform change and access logging, or automate optimization. In some embodiments, the exemplary DBMS-managed database may be chosen from Oracle database, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, or objects. In some embodiments, the exemplary DBMS-managed database may be specifically programmed to include metadata about the data that is stored.

### User Interface for Event Input Module 220

This chat-based interface module 220 provides a seamless way for users to receive event recommendations based on their specified inputs. The user interface for event input (chat-based) module 220 may be configured to control processes or operations for automatically recommending optimal event dates. This module may solicit event information directly from the user, including event details such as preferences for timing, location, and other event-specific attributes. Alternatively, the information may be gathered through a chat-bot assistant that prompts the user to provide necessary details to ensure all relevant event attributes are received. The user preferences can include factors like preferred event times, types of venues, and other personal scheduling preferences, while the attributes of the planned event can refer to the nature of the event (e.g., open house, conference, etc.), location, and other event-specific details. These attributes are essential for the decision logic and date recommendation module 260 to generate the most suitable event dates that will maximize attendance and meet user expectations.

This module 200 may be in communication with various data stores, such as the weather data store 250, historical event attendance data store 251, machine learning model data store 252, event scheduling data store 253, real-time data store 254, user data store 255, and logs and audit data store 256. These data stores provide the necessary data for processing weather forecasts, historical event data, and user preferences to recommend the best event dates. In some embodiments, each of these data stores may include data in a structured format, such as tables, arrays, or text. Each data item in the stores may also include associated metadata, such as weather conditions (e.g., temperature, wind speed, precipitation), user preferences, event scheduling details, attendance history, real-time weather updates, and system logs for auditing and feedback purposes. This metadata plays a critical role in ensuring that the system accurately predicts the most favorable event dates based on weather forecasts and past trends.

In some embodiments, the user interface for event input (chat-based) module 220 operates as an event co-host by prompting for additional event attributes when a required attribute is missing, ambiguous, or inconsistent. For example, the module 220 prompts the user to confirm whether the planned event is indoor or outdoor, whether guests will be standing or seated, whether food service is expected, and whether a backup venue is available, thereby ensuring the weather-driven event optimization system receives sufficient structured attributes for downstream recommendation generation.

In some embodiments, the module 220 receives, via the chat-based interface, an identification of one or more invitees for the planned event. The identification can include invitee account handles, invitee device identifiers, contact records, or invite links. When an invitee is associated with an account in the weather-driven event optimization system, the module 220 enables retrieval of aggregated preference signals usable to personalize event atmosphere recommendations, including food, music, lighting, and seating recommendations.

### Weather Data Acquisition Module 230

The weather data acquisition, processing, and integration module 230 is responsible for retrieving and processing real-time weather data, historical weather information, and forecasts from external sources. This module is in communication with the weather data store 250, where it stores and retrieves data such as temperature, precipitation, wind speed, and sunshine forecasts. The module ensures that accurate and up-to-date weather data is integrated into the system for optimal event scheduling. In some embodiments, the weather data store 250 may contain data in structured formats, such as tables or time-series records. Additionally, the module processes and preprocesses the weather data to handle inconsistencies, such as missing values, and to ensure that all relevant weather features are extracted for further use in predictive modeling. Metadata associated with the weather data, such as location, time of retrieval, and forecast accuracy, is stored in the weather data store 250 and is used to provide context for event recommendations. This processed data is then fed into the predictive modeling module 242 and decision logic and date recommendation module 260 to generate accurate event date suggestions based on the current and forecasted weather conditions.

### Historical Event Data Integration Module 240

The historical event data integration module 240 is responsible for collecting and processing historical event data, including past event attendance, event types, and associated weather conditions. This module interfaces with the historical event attendance data store 251, where it stores and retrieves event data such as the number of attendees, event date, location, and related weather data. By analyzing past events, this module helps the system understand the correlation between weather patterns and event attendance, improving future predictions. In some embodiments, the historical event attendance data store 251 contains structured data formats, such as tables or arrays, that include metadata such as event type, attendance count, event timing, and weather conditions during the event. This data is used to identify patterns and trends, which are then fed into the predictive modeling module 242 and the decision logic and date recommendation module 260 to refine event scheduling recommendations. The historical event data is also essential for enhancing the system's continuous learning and adaptation module 270, allowing the system to improve its accuracy by learning from past event performance in relation to weather conditions.

### Predictive Modeling and Machine Learning Module 242

The weather-driven event optimization system 202 leverages machine learning to analyze data from multiple sources, including weather forecasts, historical event attendance, and user preferences, to generate optimized event scheduling recommendations. The predictive modeling module 242 uses various machine learning techniques, such as decision trees, random forests, neural networks, and support vector machines, to predict event attendance based on these factors. These models are trained on data from the historical event attendance data store 251 and the weather data store 250, helping to identify patterns and correlations that influence event success.

In some embodiments, the system utilizes an exemplary neural network, such as a feedforward neural network or a recurrent neural network, to process and analyze input data. The training process for these models involves defining the neural network architecture, transferring input data, training the model incrementally, and evaluating its accuracy over several iterations. Once trained, the model can be applied to real-time data to predict optimal event dates based on changing weather conditions.

Additionally, the system benefits from continuous learning and adaptation, as it can refine its predictions based on real-time weather updates and post-event performance feedback. This feedback is gathered from the real-time data store 254 and historical event attendance data store 251 and is used to adjust the model's parameters for future predictions. This ensures that the model becomes more accurate and efficient over time, providing increasingly reliable event date recommendations.

### Decision Logic and Date Recommendation Module 260

The decision logic and date recommendation module 260 takes the predictions generated by the predictive modeling module 242 and applies rules based on predefined thresholds and user preferences to recommend the most optimal event dates. This module 260 works with the event scheduling data store 253, where the scheduled event details are stored, ensuring that the system takes into account real-time weather data, historical attendance patterns, and user-specified preferences when making date recommendations. The user data store 255 is also consulted to ensure that the recommendations align with the user's specific needs, such as preferred event times or venue types. This module 260 produces a list of optimal dates, ranked by their predicted likelihood of maximizing event attendance.

In some embodiments, the decision logic and date recommendation module 260 further generates non-date recommendations that improve an event outcome. For example, the module 260 selects a set of curated purchases, services, or upgrades based on (i) forecast parameters associated with the highest-ranking date, (ii) event attributes received via the user interface for event input (chat-based) module 220, and (iii) learned correlations between similar events and attendance or satisfaction metrics. In some embodiments, the module 260 stores these recommendations in the event scheduling data store 253 and transmits them to the client computing device for presentation via the chat interface.

### Continuous Learning and Adaptation Module 270

The continuous learning and adaptation module 270 allows the system to improve over time by learning from new data. As events are scheduled and executed, this module evaluates the actual attendance versus predicted attendance, adjusting the model's parameters based on the feedback. It interacts with the logs and audit data store 256, which tracks system performance and user interactions, enabling the system to learn from both successful and unsuccessful recommendations. This module ensures that the system's predictions become increasingly accurate as more data is collected, allowing the system to continuously adapt to new trends in user preferences and weather patterns.

### Event Scheduling Module 280

The user interaction and event scheduling module 280 is responsible for facilitating user interactions with the system. Through this module, users can input event details, view recommended event dates, and adjust preferences. The client computing device 110 communicates with this module, ensuring that users can receive event scheduling suggestions and modify them based on their own needs. The module 280 ensures that the system is user-friendly, providing clear recommendations and allowing for real-time updates based on changing weather conditions and event details.

In some embodiments, the user interaction and event scheduling module 280 presents alternate experience plans for user selection. For example, if the planned event is scheduled outdoors and updated forecasts indicate precipitation or wind conditions above a threshold, the module 280 presents options that convert the event to an indoor layout, apply a rain-compatible theme, or enable a hybrid virtual extension, and receives user selection input to update stored event attributes and scheduling records accordingly.

### Real-Time Weather Updates and Alerts Module 290

The real-time weather updates and alerts module 290 provides continuous monitoring of weather conditions to ensure the system can dynamically adjust recommendations as the event date approaches. This module is in constant communication with the weather data store 250 and real-time data store 254 to keep track of any significant weather changes that could impact the event. If the weather forecast changes suddenly, such as the appearance of a storm or a temperature drop, this module ensures that users are notified immediately and that recommendations are updated accordingly. It enables the system to provide real-time, actionable alerts that help users adapt their plans and ensure a successful event.

In some embodiments, the real-time weather updates and alerts module 290 triggers generation of an alternate experience plan based on a detected forecast change relative to a baseline forecast used to select the highest-ranking date. For example, the module 290 detects a threshold change in precipitation probability, wind speed, or temperature and causes the weather-driven event optimization system to (i) generate an updated ranked list of dates, (ii) generate a plan B experience for the currently scheduled date, or (iii) generate both and present them via the client computing device.

### Post-Event Performance Data Analysis Module 292

Finally, the post-event performance data analysis module 292 evaluates the success of each event after it takes place by comparing actual attendance to the predictions made by the system. In some embodiments, the module 292 further evaluates event outcome indicators and feedback associated with curated recommendations and alternate experience plans, and stores derived training features in the machine learning model data store 252 for subsequent model refinement.

### Process

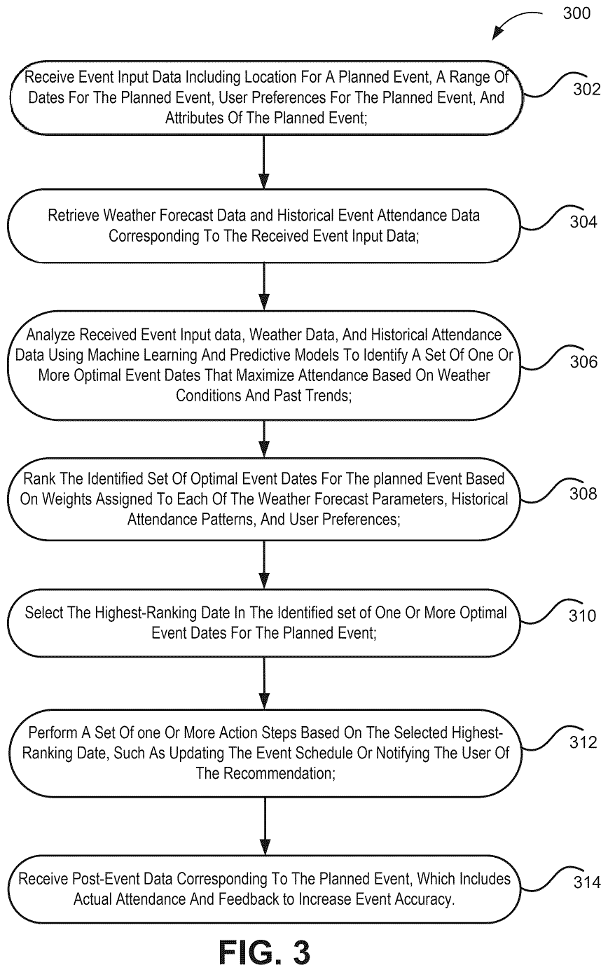

With reference now to FIG. 3, a flowchart illustrating a process 300 for selecting an optimal date for a planned event based on weather forecast data and historical event attendance data and, in some embodiments, generating event experience recommendations responsive to the selected date and forecast conditions, is shown in accordance with an illustrative embodiment. The process shown in FIG. 3 may be implemented in a computing component, such as, for example, weather-driven event optimization server 102 illustrated in FIGS. 1A-1B, client computing device 110 illustrated in FIGS. 1A-1B, or weather-driven event optimization server 202 in FIG. 2.

The process begins when the weather-driven event optimization system receives event input data that includes at least one of a location for a planned event, a range of dates for the planned event, user preferences for the planned event, and attributes of the planned event (step 302). For example, the user interface for event input (chat-based) module 220, illustrated in FIG. 2, facilitates this data entry by receiving event information provided by the user, and, in some embodiments, by soliciting missing event information through a chat-bot assistant so that the location, the range of dates, the user preferences, and the attributes of the planned event are received for downstream processing.

Next, the weather-driven event optimization system retrieves weather forecast data and historical event attendance data corresponding to the received event input data (step 304). For example, the weather data acquisition, processing, and integration module 230, illustrated in FIG. 2, retrieves forecast data and related weather information for the event location, and the historical event data integration module 240 retrieves historical attendance data for similar events, including attendance outcomes associated with prior dates and weather conditions.

Subsequently, the weather-driven event optimization system analyzes the received event input data, the retrieved weather forecast data, and the retrieved historical event attendance data using machine learning and predictive models to identify a set of one or more optimal event dates that maximize attendance based on weather conditions and past trends (step 306). For example, the predictive modeling module 242, illustrated in FIG. 2, generates predicted attendance values, predicted attendance ranges, or predicted attendance scores for candidate dates within the range of dates, based on feature values derived from the weather forecast data, the historical event attendance data, and the received user preferences and event attributes.

Further, the weather-driven event optimization system ranks the identified set of optimal event dates for the planned event based on weights assigned to each of the weather forecast parameters, historical attendance patterns, and user preferences (step 308). For example, the decision logic and date recommendation module 260, illustrated in FIG. 2, applies weighting rules, thresholds, and constraints to produce a ranked list of the optimal event dates. The weather-driven event optimization system then selects a highest-ranking date in the identified set of one or more optimal event dates for the planned event (step 310). In some embodiments, the decision logic and date recommendation module 260 selects the highest-ranking date based on a predicted attendance output of the predictive modeling module 242 while also satisfying user-provided constraints reflected in the received user preferences and attributes of the planned event.

Next, the weather-driven event optimization system performs a set of one or more action steps based on the selected highest-ranking date, such as updating the event schedule or notifying the user of the recommendation (step 312). For example, the user interaction and event scheduling module 280, illustrated in FIG. 2, facilitates the interaction between the system and the user by presenting the selected highest-ranking date through the chat-based interface, receiving user confirmation or modifications, and updating an event schedule record based on the user response. Additionally, the real-time weather updates and alerts module 290 monitors updated forecast data for the event location and, when a change satisfies an alert condition or a reschedule condition, causes the weather-driven event optimization system to generate an updated recommendation for dates and to transmit a notification to the user through the chat-based interface.

Finally, the weather-driven event optimization system receives post-event data corresponding to the planned event, which includes actual attendance and feedback (step 314). In some embodiments, the feedback includes user-provided ratings, invitee engagement indicators, and event outcome indicators associated with atmosphere recommendations, including food, music, lighting, seating, and plan B selections. For example, this data is collected through the post-event performance data analysis module 292, illustrated in FIG. 2, which compares actual attendance and outcome indicators with predicted values.

In some embodiments, the weather-driven event optimization system applies machine learning to the post-event data to increase event date selection accuracy for future events. For example, the continuous learning and adaptation module 270, illustrated in FIG. 2, updates at least one model stored in the machine learning model data store 252 based on an error between predicted attendance and actual attendance, and the updated model is used by the predictive modeling module 242 for subsequent event date recommendations. Thereafter, the process terminates.

The process begins when the weather-driven event optimization system receives event input data that includes at least one of the following: a location for the planned event, a range of dates for the planned event, user preferences for the event, and attributes of the planned event (e.g., event type, location, and timing). For example, the user interface for event input (chat-based) module 220, illustrated in FIG. 2, facilitates this data entry, either by gathering the data directly from the user or soliciting the necessary event attributes through the chat-bot assistant.

Next, the weather-driven event optimization system retrieves weather forecast data and historical event attendance data corresponding to the received event input data (step 304). For example, the weather data acquisition, processing, and integration module 230, illustrated in FIG. 2, retrieves real-time weather forecasts and historical weather data, while the historical event data integration module 240 collects past event attendance data. These modules ensure that the necessary data is gathered to inform event date recommendations.

Subsequently, the weather-driven event optimization system analyzes the received event input data, weather data, and historical attendance data using machine learning and predictive models and predictive algorithms to identify a set of one or more optimal event dates that maximize attendance based on weather conditions and past trends (step 306). This step is performed by the predictive modeling module 242, as illustrated in FIG. 2, which uses the data to predict the optimal event dates based on weather conditions and past attendance trends. The system generates a set of one or more optimal event dates.

Further, the weather-driven event optimization system ranks the identified set of optimal event dates for the planned event based on weights assigned to each of the weather forecast parameters (e.g., temperature, precipitation), historical attendance patterns, and user preferences (step 308). For example, this step is managed by the decision logic and date recommendation module 260, illustrated in FIG. 2, which applies predefined rules and logic to ensure the highest-ranking dates are selected. The weather-driven event optimization system then selects the highest-ranking date in the identified set of one or more optimal event dates for the planned event (step 310). This date is chosen based on predicted attendance and favorable weather conditions. The decision logic and date recommendation module 260 ensures that the highest-ranking date aligns with the user's needs and preferences, as well as the weather data.

Next, the weather-driven event optimization system performs a set of one or more action steps based on the selected highest-ranking date, such as updating the event schedule or notifying the user of the recommendation (step 312). For example, the user interaction and event scheduling module 280 illustrated in FIG. 2, facilitates the interaction between the system and the user. It allows the user to review, modify, and finalize event scheduling recommendations. Once the highest-ranking date is selected (e.g., based on weather forecasts and historical data), the user interaction and event scheduling module 280 performs actions like updating the schedule, notifying the user of the recommended date, and handling any modifications or changes made by the user. This module ensures that the event is scheduled in a user-friendly way, allowing the user to easily interact with the system's recommendations. Additionally, the real-time weather updates and alerts module 290 ensures that the system is constantly updated with real-time weather data. If there are significant changes in weather conditions (e.g., a storm or temperature fluctuation), this module provides alerts and adjusts the event recommendations dynamically.

Finally, the weather-driven event optimization system receives post-event data corresponding to the planned event, which includes actual attendance and feedback (step 314). For example, his data is collected through the post-event performance data analysis module 292, illustrated in FIG. 2, which compares actual attendance with predicted attendance.

The weather-driven event optimization system applies machine learning to the post-event data to increase event date selection accuracy for future events. Thereafter, the process terminates.

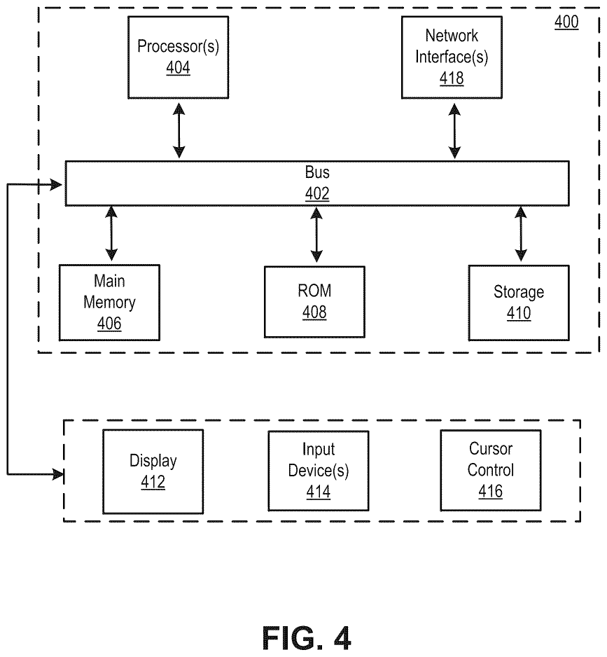

### System

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 4. Various embodiments are described in terms of this example computing module 400. After reading this description, it will become apparent to a person skilled in the relevant art how to implement the technology using other logical circuits or architectures.

FIG. 4 illustrates an example computing module 400, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 4. Various embodiments are described in terms of this example-computing module 400. After reading this description, it will become apparent to a person skilled in the relevant art how to implement the application using other computing modules or architectures.

Referring now to FIG. 4, computing module 400 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing module 400 or to communicate externally. The bus 402 may also be connected to other components such as a display 412, input devices 414, or cursor control 416 to help facilitate interaction and communications between the processor and/or other components of the computing module 400.

Computing module 400 might also include one or more memory modules, simply referred to herein as main memory 406. For example, preferably random-access memory (RAM) or other dynamic memory might be used for storing information and instructions to be executed by processor 404. Main memory 406 might also be used for storing temporary variables or other intermediate information during execution of instructions to be executed by processor 404. Computing module 400 might likewise include a read only memory (“ROM”) 408 or other static storage device 410 coupled to bus 402 for storing static information and instructions for processor 404.

Computing module 400 might also include one or more various forms of information storage devices 410, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 410 might include other similar instrumentalities for allowing computer programs or other instructions or data to be loaded into computing module 400. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 400.

Computing module 400 might also include a communications interface or network interface(s) 418. Communications or network interface(s) interface 418 might be used to allow software and data to be transferred between computing module 400 and external devices. Examples of communications interface or network interface(s) 418 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 418 might typically be carried on signals, which can be electronic, electromagnetic (which includes optical) or other signals capable of being exchanged by a given communications interface. These signals might be provided to communications interface 418 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 406, ROM 408, and storage unit interface 410. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 400 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A computer-implemented method for optimizing event scheduling based on weather forecasts and historical event attendance data, comprising:
acquiring, by at least one processor, weather forecast data for an event location;
analyzing, by the at least one processor, historical attendance data for similar events;
predicting, by the at least one processor, event attendance based on weather data and historical trends;
recommending, by the at least one processor, alternative event dates with more favorable weather conditions.

2. The method of claim 1, wherein the weather data includes temperature, precipitation, wind speed, and sunlight levels.

3. The method of claim 2, wherein the event is an open house for a real estate listing.

4. The method of claim 3, further comprising providing, by the at least one processor, real-time updates and adaptive recommendations based on changing weather conditions.

5. The method of claim 4, wherein the event recommendation model is based on a machine learning algorithm that integrates weather data and historical attendance data to optimize event scheduling.

6. A system comprising:
one or more computing processors; and
a machine-readable storage medium storing instructions that, when executed by the one or more processors, cause the system to:
acquire weather forecast data for an event location;
analyze historical attendance data for similar events;
predict event attendance based on weather data and historical trends;
recommend alternative event dates with more favorable weather conditions.

7. The system of claim 6, wherein the weather data includes temperature, precipitation, wind speed, and sunlight levels.

8. The system of claim 6, wherein the event is an open house for a real estate listing.

9. The system of claim 6, wherein the machine-readable storage medium storing instructions that, when executed by the one or more processors, further cause the system to provide real-time updates and adaptive recommendations based on changing weather conditions.

10. The system of claim 6, wherein the event recommendation model is based on a machine learning algorithm that integrates weather data and historical attendance data to optimize event scheduling.

11. A computer-implemented method for providing visual weather-perspective previews for a planned event, comprising:
receiving, via a chat-based interface at a client computing device, event input data that includes a planned event location and dates for a planned event;
receiving image data captured by a vision camera associated with the client computing device, the image data depicting a physical space associated with the planned event location;
receiving location data from the client computing device, wherein the location data includes GPS-derived coordinates;
preserving the GPS-derived coordinates by storing the GPS-derived coordinates in association with the planned event and the image data;
repurposing the GPS-derived coordinates by selecting, using the GPS-derived coordinates, weather forecast data for a geographic area corresponding to the planned event location;
generating, using an imaging subsystem executed by a server, a set of visual previews of the physical space under different forecasted weather conditions based on the weather forecast data; and
transmitting, to the client computing device, the set of visual previews for presentation via the chat-based interface to support selection of a date for the planned event.

12. The method of claim 11, wherein generating the set of visual previews comprises generating at least two of a sun preview, a rain preview, a snow preview, or an overcast preview.

13. The method of claim 11, wherein generating the set of visual previews comprises applying an environmental transform to the image data based on one or more forecast parameters that include at least one of temperature, precipitation probability, wind speed, or sunlight level.

14. The method of claim 11, wherein generating the set of visual previews comprises rendering a simulated overlay on the image data based on forecast parameters received from an external services server.

15. The method of claim 11, further comprising receiving, via the chat-based interface, user preferences for the planned event that include at least one of an indoor preference, an outdoor preference, a preferred time window, a tolerance threshold for precipitation, or a tolerance threshold for wind.

16. The method of claim 15, further comprising ranking the dates for the planned event based on (i) predicted attendance determined from historical event attendance data and (ii) forecast parameters, wherein the ranking is constrained by the user preferences.

17. The method of claim 16, further comprising selecting a recommended date from the ranked dates, and presenting, via the chat-based interface, (i) the recommended date and (ii) a corresponding visual preview selected from the set of visual previews that matches a forecasted condition for the recommended date.

18. The method of claim 11, further comprising detecting an updated forecast for the planned event location that satisfies a reschedule condition relative to a baseline forecast used to generate the set of visual previews, and in response, transmitting an alert to the client computing device via the chat-based interface that includes an updated recommended date or an updated set of visual previews.

19. The method of claim 18, wherein the reschedule condition comprises a change that exceeds a threshold in at least one of precipitation probability, wind speed, or temperature for a currently scheduled date.

20. A system for providing visual weather-perspective previews for a planned event, comprising:
one or more processors; and
a non-transitory computer readable medium storing instructions that, when executed by the one or more processors, cause the system to:
receive, via a chat-based interface presented at a client computing device, event input data that includes a planned event location and dates for a planned event;
receive image data captured by a vision camera associated with the client computing device, the image data depicting a physical space associated with the planned event location;
receive location data from the client computing device, wherein the location data includes GPS-derived coordinates;
preserve the GPS-derived coordinates by storing the GPS-derived coordinates in association with the planned event and the image data; repurpose the GPS-derived coordinates by selecting, using the GPS-derived coordinates, weather forecast data for a geographic area corresponding to the planned event location;
generate, using an imaging subsystem, a set of visual previews of the physical space under different forecasted weather conditions based on the weather forecast data; and
transmit, to the client computing device, the set of visual previews for presentation via the chat-based interface to support selection of a date for the planned event.

21. The system of claim 20, wherein the instructions cause the system to generate at least two of a sun preview, a rain preview, a snow preview, or an overcast preview.

22. The system of claim 20, wherein the instructions cause the system to generate the set of visual previews by applying an environmental transform to the image data based on one or more forecast parameters that include at least one of temperature, precipitation probability, wind speed, or sunlight level.

23. The system of claim 20, wherein the instructions cause the system to generate the set of visual previews by rendering a simulated overlay on the image data based on forecast parameters received from an external services server.

24. The system of claim 20, wherein the instructions cause the system to receive, via the chat-based interface, user preferences for the planned event that include at least one of an indoor preference, an outdoor preference, a preferred time window, a tolerance threshold for precipitation, or a tolerance threshold for wind.
